(19) United States
(12) Patent Application Publication
(10) Pub. No.: US 2002/0144977 A1
(43) Pub. Date: Oct. 10, 2002

(54) Electrode of a vacuum valve, a producing method thereof, a vacuum valve, a vacuum circuit-breaker and a contact point of the electrode

(76) Inventors: Shigeru Kikuchi, Tokai (JP); Masaya Takahashi, Hitachi (JP); Noboru Baba, Hitachiota (JP); Masato Kobayashi, Hitachi (JP); Yoshitomo Goto, Hitachi (JP); Yasuaki Suzuki, Hitachi (JP); Takashi Sato, Hitachi (JP)

Correspondence Address: MATTINGLY, STANGER & MALUR. P.C., ATTORNEYS AT LAW, SUITE 370, 1800 DIAGONAL ROAD, ALEXANDRIA, VA, 22314, US

(21) Appl. No.: 09/971,915

(22) Filed: Oct. 9, 2001

(30) Foreign Application Priority Data
Feb. 14, 2001 (JP) 2001-037323

(51) Int. Cl. H01H 33/66; H01R 43/16

(52) U.S. Cl. 218/123; 218/118; 29/875; 29/878

(57) ABSTRACT

The inventive electric contact point of a vacuum valve is made of a sintered alloy containing a heat-resistant metal and a high-conductivity metal. The contact point has at least three slit grooves which extend from the central region to the peripheral region of the contact point, and is soldered to an electrode rod which is connected to the contact point. The contact point includes at least three radially extending vane type contact point members each made of a sintered alloy containing a heat-resistant metal and a high-conductivity metal, and soldered to the electrode rod.

### BACKGROUND OF THE INVENTION

The present invention relates to a new electrode of a vacuum valve, a producing method thereof, a vacuum valve, a vacuum circuit-breaker and a contact point of the electrode.

### PRIOR ART

An electrode structure installed in a vacuum valve of a vacuum circuit-breaker has a pair of a stationary electrode and a movable electrode. Each of the stationary and the movable electrodes comprises an electric contact point (hereinafter referred to as “contact point”) and an electrode rod connected to the contact point. In addition, the electrode often has a reinforcement plate, which is made of a stainless steel, for example, and mounted on the back of the contact point. A Cr-Cu composite alloy is often used as a material for a large-current and a high-voltage breaker contact point.

The contact points are manufactured by a powder metallurgy method, in which a previously alloyed metal powder or a powder mixture of elemental metal powders having a predetermined chemical composition is compacted to have a simple form such as a disk, subsequently the compact is sintered and machined to a contact point member having a desired form.

It is noted that a typical contact point is provided with slit grooves so as to have a vane type divided form slit grooves in order to move arose arcs to the peripheral region of the contact point without allowing the arcs to stay at a single position of the contact point. On the other hand, the electrode rod is cut out of a pure Cu material and machined to a desired shape.

The thus machined members are assembled and soldered to be an electrode structure. However, since the sintered electrode members thus formed have a relatively large number of pores, there is a concern that, when machining oil is used during machining, the oil stays in the pores whereby adversely affecting breaker performance of the vacuum valve. Therefore, the sintered members are machined to form the slit grooves, for example, by an end mill without using machining oil, so-called dry machining. However, since dry machining has shortcomings of a short life of machining tools and a slow machining speed, there have been problems of a low productivity and a high production cost.

In order to solve the problems, when compacting a raw metal powder, a vane type divided form of contact point having slit grooves is previously provided to the compact followed by sintering to obtain a product of contact point. This method is disclosed in JP-A-2000-149732 and takes an advantage of contraction of the contact point member when sintering, thereby causing the contact point member to be pressure-fitted on the electrode rod. According to the producing method of compacting the metal powder to form a contact point and sintering the formed compact, no post-sintering machining is required, so that the production cost can be reduced and the productivity is greatly improved in producing contact points.

On the other hand, however, according to the solution method, a raw metal powder must be compacted to produce a complex form. Thus, it is difficult to uniformly fill the raw metal powder in a forming die, so that the compacted member has not a uniform density and a great shrinkage occurs during sintering, resulting in an undesirable form of the contact point. Besides, the sintered contact point has a low density resulting in deteriorated performance as a circuit-breaker.

The above producing method has defects that it requires a complex press forming machine and a complex forming die for producing a complex contact point, so that there arises a problem of increased production cost for the electrode.

### BRIEF SUMMARY OF THE INVENTION

Thus, an object of the invention is to provide a sound and reliable high-density electrode of a vacuum valve, a vacuum valve with the electrode, a vacuum circuit-breaker and a contact point of the electrode.

According to a first aspect of the invention, there is provided an electrode of a vacuum valve, comprising a contact point being made of a sintered alloy comprising a heat-resistant metal and a high-conductivity metal; an electrode rod being bonded to the contact point by soldering to the contact point, wherein the contact point has at least three slit grooves each extending from the central region to the peripheral region of the contact point.

According to a second aspect of the invention, there is provided an electrode of a vacuum valve, comprising a contact point being made of a sintered alloy comprising a heat-resistant metal and a high-conductivity metal; a reinforcement plate being connected to the back surface of the contact point; and an electrode rod being connected to the contact point and the reinforcement plate, wherein the reinforcement plate is soldered to the contact point and the electrode rod; and the contact point has at least three slit grooves extending from the central region to the peripheral region of the contact point.

The contact point preferably has a recess at the center thereof.

According to a third aspect of the invention, there is provided an electrode of a vacuum valve, comprising: a contact point having a vane type divided form being made of a sintered alloy comprising a heat-resistant metal and a high-conductivity metal; a circular contact point member being made of a sintered alloy comprising a heat-resistant metal and a high-conductivity metal and arranged at the inner circumferential region of the contact point; and an electrode rod being connected to the circular contact point member, wherein the circular contact point member and the electrode rod are bonded by soldering with each other; and the contact point having a vane type divided form has at least three vane type members which are arranged around the circular contact point member as if they form a vane wheel.

According to a fourth aspect of the invention, there is provided an electrode of a vacuum valve, comprising: a contact point having a vane type divided form made of a sintered alloy comprising a heat-resistant metal and a high-conductivity metal; a circular contact point member being made of a sintered alloy comprising a heat-resistant metal and a high-conductivity metal, and arranged at the inner circumferential region of the contact point; and an electrode rod connected to the circular contact point member, wherein the contact point and circular contact point member are bonded with each other by soldering; the circular contact point member and the electrode rod are bonded with each other by soldering; and wherein the contact point has at least three vane type members which are arranged around the circular contact point member as if they form a vane wheel.

According to a fifth aspect of the invention, there is provided an electrode of a vacuum valve, comprising: a contact point having a vane type divided form made of a sintered alloy comprising a heat-resistant metal and a high-conductivity metal; a reinforcement plate being connected to the back surface of the contact point; a circular contact point member being made of a sintered alloy comprising a heat-resistant metal and a high-conductivity metal, and arranged at the inner circumferential region of the contact point; and an electrode rod connected to the circular contact point-member, wherein the contact point and the reinforcement plate are bonded with each other by soldering; the circular contact point member and the electrode rod are bonded with each other by soldering; and wherein the contact point has at least three vane type members which are arranged around the circular contact point member as if they form a vane wheel.

The circular contact point member preferably comprises a lower amount of the heat-resistant metal than the contact point having a vane type divided form.

The circular contact point member preferably has an electric conductivity larger than the contact point having a vane type divided form.

The circular contact point member is preferably provided with a recess at the center thereof.

According to a sixth aspect of the invention, there is provided a method of manufacturing an electrode of a vacuum valve, the electrode comprising: a contact point being made of a sintered alloy comprising a heat-resistant metal and a high-conductivity metal; and an electrode rod being bonded to the contact point by soldering to the contact point, wherein the contact point has at least three slit grooves each extending from the central region to the peripheral region of the contact point, the method comprising the steps of: compacting an alloy powder comprising a heat-resistant metal and a high-conductivity metal, or a mixture of a heat-resistant metal powder and a high-conductivity metal powder to have a predetermined form; and sintering the thus obtained compact by heating.

According to a seventh aspect of the invention, there is provided a method of manufacturing an electrode of a vacuum valve, the electrode comprising: a contact point having a vane type divided form made of a sintered alloy comprising a heat-resistant metal and a high-conductivity metal; and an electrode rod being bonded to the contact point by soldering to the contact point, wherein the contact point has at least three vane type members which are arranged around the electrode rod as if they form a vane wheel the method comprising the steps of: compacting an alloy powder comprising a heat-resistant metal and a high-conductivity metal, or a mixture of a heat-resistant metal powder and a high-conductivity metal powder to have a predetermined form; and sintering the thus obtained compact by heating.

The vacuum valve of the invention has a stationary electrode and a movable electrode in an electrically insulated container, wherein both of the electrodes are those described above.

According to an eighth aspect of the invention, there is provided a vacuum circuit-breakervalvevalve having: a vacuum valve having a stationary electrode and a movable electrode in a vacuum container; conductive terminals connected with the respective stationary and movable electrodes; an opening/closing means for driving the movable electrode, the vacuum circuit-breaker comprising the vacuum valve described above.

According to a ninth aspect of the invention, there is provided a contact point of an electrode of a vacuum valve, comprising a sintered alloy slab of a heat-resistant metal and a high-conductivity metal, wherein the contact point has at least three slit grooves extending from the central region to the peripheral region of the contact point. The contact point comprises a vane type contact point having a flat plate form and being made of a sintered alloy comprising a heat-resistant metal and a high-conductivity metal.

An electrode of a vacuum valve of the invention has an electrode rod connected to the contact point of the electrode and a reinforcement plate between the contact point and the electrode rod. The contact point is provided with curved slit grooves, for moving electric arcs from occurrence points thereof, so as to have a vane type divided form. Such a structure of the contact point can be obtained by filling a raw metal powder in a die for forming the vane type contact point member and compacting the powder, followed by sintering and circumferentially arranging a plurality of the sintered products spaced apart with one another with a constant distance. The vane type contact point member has a uniform and high density because of a simple form, so that it exhibits a stable performance of a circuit breaker. Since the vane type contact point member has a simple form, a press machine and a forming die are not expensive, thereby enabling cost reduction in manufacturing the electrode. Further, when the vane type contact point member is optionally subjected to dry machining after sintering, the machining can be carried out in a short time since it has a simple form.

While the contact point is produced by arranging a plurality of the vane type contact point members circumferentially, it is possible to arbitrarily select a diameter of the contact point by changing the distance among the arranged contact point members or the number thereof. Thus, it is possible to produce contact points, having different capacities of from a small to a large one with one another, by using the same contact point members at a low production cost, whereby vacuum valves can be provided at a low price.

It is also possible to make the electric contact surface of the contact point flat without steps or projections/recesses by arranging a circular contact point member at the center so as to cover the uneven surface at the central jointing region of the vane type contact point members when the contact point is produced by arranging the plural contact point members circumferentially, whereby preventing local generation of heat due to a contact resistance when closing a circuit breaker and arc concentration when opening the circuit breaker.

The circular contact point member can have a higher conductivity than that of the vane type contact point member by making the content of the heat-resistant metal of the circular contact point member smaller than that of the vane type contact point members, where by the central circular contact point member serves to conduct electricity during conductive operation, while the surrounding vane type contact point members have voltage-withstanding property and resistance to melt when opening a circuit breaker. Particularly, the contact point can exhibit excellent breaking property by providing the surrounding vane type contact point members with such voltage-withstanding property and resistance to melt, because arcs generated when breaking a circuit move to the outer periphery side of the vane type contact point members along the slit grooves formed therebetween.

According to the above contact point, when breaking, it is possible to prevent occurrence of a non-operative state due to an arc stay phenomenon at the center of the contact point in the case of a contact point having a central recess.

The heat-resistant metal preferably comprises impurities of 50 to 2000 ppm oxygen, 50 to 3000 ppm aluminum (Al) and 400 to 2500 ppm silicon (Si) which improve breaking performance of the contact point because of their excellent arc extinction effect. Aluminum and silicon may exist as oxides. If aluminum and silicon oxides are dispersed uniformly in the heat-resistant metal, excellent voltage-withstanding property and resistance to melt can be obtained. If the amounts of oxygen, Al, and Si are smaller than the respective amounts mentioned above, the amounts of aluminum and silicon oxides will be insufficient to attain the desired improvement in operation performance. On the other hand, if the amounts of Al and Si are excessive than those mentioned above, an increased amount of gas will be generated when oxides are decomposed by the arc heat at the breaking time resulting in deteriorated voltage-withstanding property and resistance to melt.

The compacting pressure to form the contact point member is preferably in the range of 120 to 500 MPa. If the pressure is less than 120 MPa, the formed compact will have a smaller density and be easily broken. If the pressure is higher than 500 MPa, the formed compact will have a higher density but, after sintering, the resultant point member will have a rather low density.

The heat-resistant metal, which is a first component(s) of the formed compact for the contact point member, consists of one or more elements selected from the group of Cr, W, Mo, Ta, Nb, Be, Hf, Ir, Pt, Zr, Ti, Te, Si, Rh and Ru, or an alloy comprising one of the elements as a primary element. The high-conductivity metal, which is a second component(s) of the formed compact for the contact point member, preferably consists of one or more elements selected from the group of Cu, Ag and Au, or an alloy comprising one of the elements of Cu, Ag and Au as a primary element. A preferable composition of the heat-resistant metal and the high-conductivity metal is of 15 to 40 wt % the heat-resistant metal and 60 to 85 wt % the high-conductivity metal, according to which a contact point material can be obtained, the contact point material being excellent in breaking performance and voltage-withstanding property, and having a comparatively low electric resistance. A raw powder metal, from which the compact for the contact point member is formed and which consists of the heat-resistant metal and the high-conductivity metal, has preferably a particle size of not more than 104 μm, whereby the contact point surface can have a uniform and fine texture and the contact point, which is excellent in breaking performance, voltage-withstanding property and resistance to melt and which has a high density, can be obtained. If it is difficult to fill the raw metal powder into a forming die because of a poor fluidity, an appropriate binder may be added in the raw metal powder to granulate the metal powder by means of a spray drying method prior in order to improve characteristics of the metal powder.

### BRIEF DESCRIPTION OF THE DRAWINGS

FIG. 1A is a plan view of a first embodiment of an electrode according to the invention;

FIG. 1B is a vertical cross sectional view of the electrode shown in FIG. 1A;

FIG. 2 shows a vane type contact point of the first embodiment according to the invention;

FIG. 3A is a plan view of a first embodiment of a circular contact point member according to the invention;

FIG. 3B is a vertical cross sectional view of the circular contact pint member shown in FIG. 3A.

FIG. 4A is an alternative configuration to the electrode of the first embodiment according to the invention;

FIG. 4B shows another configuration of the electrode of the first embodiment according to the invention;

FIG. 4C shows still another configuration of the electrode of the first embodiment according to the invention;

FIG. 5A shows a structure of an electrode as a second embodiment of the invention, which has a reinforcement plate;

FIG. 5B shows a vertical cross section of the electrode shown in FIG. 5A;

FIG. 6 shows a third embodiment of an integral vane typecontact point member according to the invention;

FIG. 7A is an optical microscopic photograph of the cross section of the vane type contact point member of the first embodiment;

FIG. 7B is an optical microscopic photograph of the cross section of the integral vane type contact point member of the third embodiment;

FIG. 8A shows an electrode with an integral vane type contact point member as a fourth embodiment according to the invention;

FIG. 8B is a vertical cross sectional view of the electrode shown in FIG. 8A;

FIG. 9A shows an electrode with a circular contact point member as a fifth embodiment according to the invention;

FIG. 9B is a vertical cross sectional view of the electrode shown in FIG. 9A;

FIG. 10A shows an electrode without a circular contact point member as a sixth embodiment according to the invention;

FIG. 10B is a vertical cross sectional view of the electrode shown in FIG. 10A; and

FIG. 11 is a sectional view showing a seventh embodiment of a vacuum valve according to the invention.

### BRIEF DESCRIPTION OF PREFERRED EMBODIMENTS

### Example 1

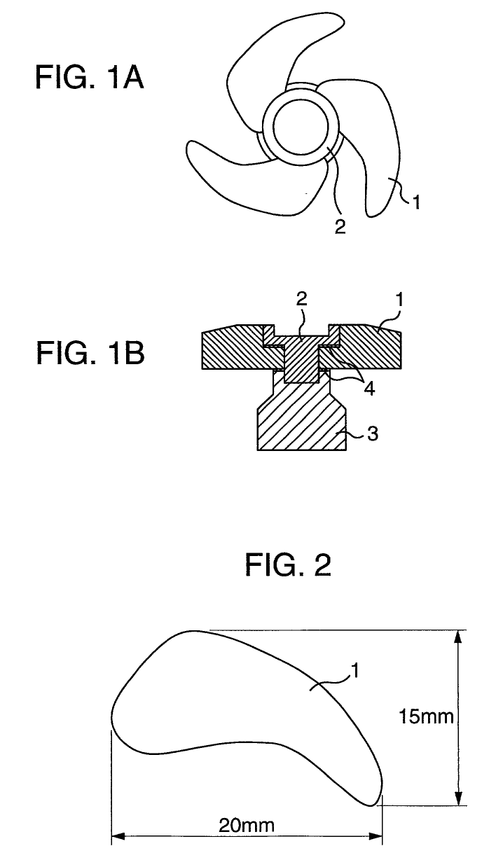

FIG. 1A is a plan view of a first embodiment of an electrode according to the invention. valve FIG. 1B is a cross sectional view of the electrode shown in FIG. 1A. The electrode comprises vane type contact point members 1, a circular contact point member 2, an electrode rod 3, and a solder 4.

The vane type contact point members 1 were manufactured as follows. A copper powder of the high-conductivity metal and a chromium powder of the heat-resistant metal were mixed with each other in a composition of 65:35 (Cu:Cr) by weight, which mixture was filled in a die having a cavity configuration by which a form of the vane type contact point member 1 can be obtained, the contact point member 1 as a sintered product having the size indicated in FIG. 2. The copper powder had a particle size of not more than 60 μm. The chromium powder had a particle size of not more than 104 μm. The amount of the metal powder mixture to be filled in the die was determined so that the sintered product has a desired thickness. The chromium powder contained impurities of 1100 ppm oxygen, 800 ppm Al, and 440 ppm Si. The filled metal powder mixture was compacted under a pressure of 250 MPa. The relative density of the formed compact was 73%. The formed compact was then heated under vacuum of not higher than 6.7×10⁻³ Pa at 1050° C. for 120 minutes. Thus, three vane type contact point members 1 having a uniform thickness, as shown FIG. 2, were produced. The sintered product had a relative density of 98%. Because of a simple configuration, the vane type contact point members could have a high-density after sintering.

The vane type contact point member 1 has a length of two times larger than the width. The proximal end of the vane type contact point member 1, which is in contact with the central circular contact point member 2, has the same curvature as the diameter of the circular contact point member 2. The width of the vane type contact point member 1 is largest at the proximal end, and gradually decreases with the distance from the proximal end. The ratio of the length to the largest width of the vane type contact point member 1 is preferably in the range of 1.5 to 2.5, and more preferably in the range of 1.7 to 2.2.

A manufacturing method of the circular contact point member 2 is described below.

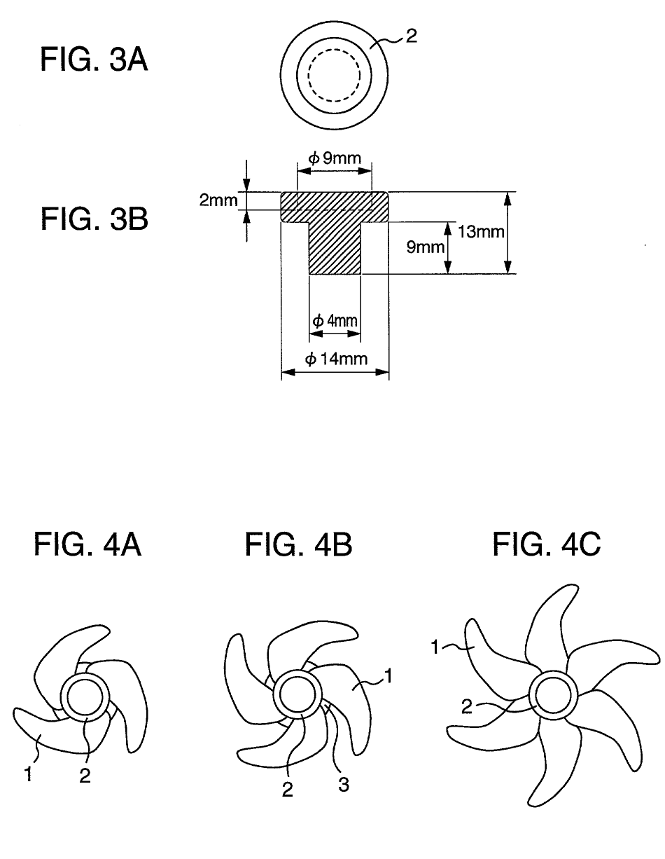

A copper powder as the high-conductivity metal and a chromium powder of the heat-resistant metal were mixed with each other in a composition of 75:25 (Cu:Cr) by weight. The powder mixture was filled in a die having a cavity configuration by which a form of the circular contact point member 2 can be obtained, the circular contact point member 2 as a sintered product having the size indicated in FIG. 3B. The powder mixture has the same particle size as the vane type contact point member 1. The filled powder mixture was compacted by a hydraulic press under 250 MPa. The relative density of the formed compact was 75%. The compact was heated under the same sintering conditions as the vane type contact point member 1 to produce a circular contact point member 2 as shown in FIGS. 3A and 3B. The sintered product has a relative density of 98%. Because of a simple configuration, the circular contact point member could have a high-density after sintering. The circular contact point member 2 comprises a cup-shaped part having a center circular recess at the center thereof, and an insertion part to be inserted into a recess of an electrode rod 3 having a smaller diameter than the inner diameter of the center circular recess. In FIGS. 2 and 3B, the unit of the dimensions indicated in is millimeter (mm).

A method of producing the electrode, as shown in FIG. 1, with utilization of the vane type contact point members 1 and circular contact point member 2 will be described below. The electrode rod 3, made of an oxygen-free copper, is machined to have a first part with the recess for receiving the insertion part of the circular contact point member 2 (see FIG. 1), and a second part comprising a connecting section having a larger diameter than that of the first part, the connecting section being connected to an outer lead member. The vane type contact point members 1 are also machined so that the circular contact point member 2 can be engaged therewith. While it is noted that the machining is preferably performed without machining oil in order to avoid penetration of the machining oil into the vane type contact point member 1, such oil-free machining can be easily performed since the vane type contact point member 1 has a relatively simple form. By providing each of the vane type contact point member 1 with a taper to decrease the thickness thereof towards the outer end, a bending deformation of the vane type contact point member 1 during opening and closing operations of the electrodes can be prevented. The vane type contact point members 1, the circular contact point member 2, and the electrode rod 3 are superimposed with interposed solders 4 therebetween in the order as shown in FIG. 1. In the embodiment, the solder 4 was of a Cu-Mn alloy. The assembly is then heated at 980° C. for eight minutes under vacuum of not higher than 8.2×10⁻⁴ Pa to obtain the electrode as shown in FIG. 1. The electrode rod 3 has a smaller diameter part being connected to the vane type contact point members 1 and a larger diameter part continuing to the smaller diameter section, whereby arcs generated at the vane type contact point members 1 can be quickly moved. Preferably the larger diameter part has a diameter of 1.3 to 2.0 times the smaller diameter part.

It is noted that, since the circular contact point member 2 made of a 25Cr-Cu alloy has a greater contraction rate than the vane type contact point members 1 made of a 35Cr-Cu alloy, it is possible to produce an electrode by a manner in which the solder 4 is provided only in the recess of the electrode rod 3 and the vane type contact point members 1 are clamped between the circular contact point member 2 and the electrode rod 3 by shrinkage fit. According to the method of shrinkage fit, it is possible to produce an electrode having a stable breaking performance without exposure of the solder, having a low melting point, on the surface of the electrode.

FIGS. 4A-4C show electrodes having different numbers of vane type contact point members 1 to one another, which are produced by the same way as the electrode shown in FIG. 1. In FIGS. 4A-4C, the electrodes have three, four and six vane type contact point members 1, respectively.

Thus, an electrode having a vane type divided structure with slit grooves can be comparatively easily produced by arranging a plurality of vane type contact point members 1 each having a simple form. It is possible to produce electrodes having different capacities of from a low level to a high level at low costs with utilization of the same components, because electrodes having different diameters to one another can be produced by simply changing the number of the vane type contact point members 1 to be used. Further, with utilization of the central circular contact point member 2 which covers the joint region of the vane type contact point members 1 at the center of the electrode, it is possible to eliminate steps whereby preventing occurrence of a sharp electric field, so that the voltage-withstanding property can be stably maintained.

### Example 2

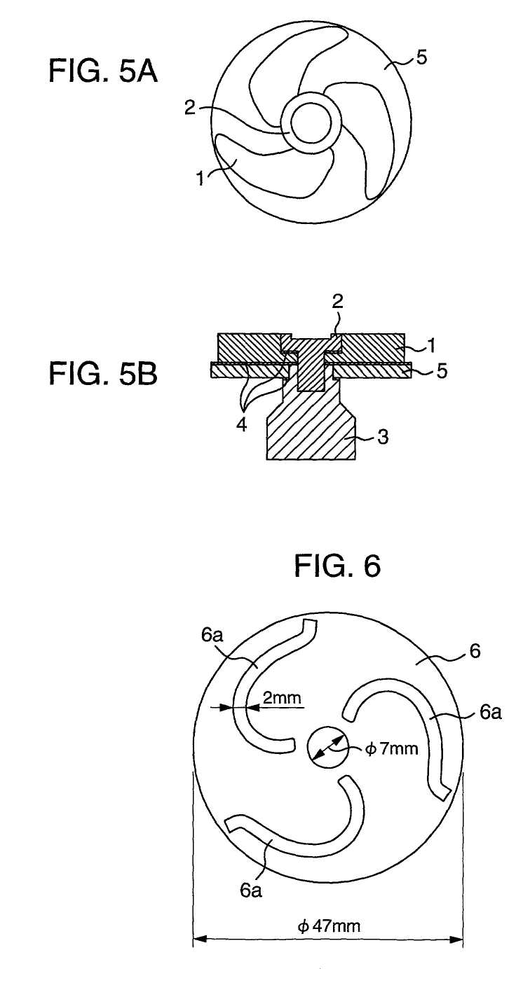

FIGS. 5A and 5B show an electrode produced by the same way as the first embodiment, which is provided with a reinforcement plate 5 on the back of the vane type contact point members 1.

This electrode is manufactured as follows. The electrode rod 3 is made of an oxygen-free copper like as in the first embodiment. The reinforcement plate 5 made of stainless steel of JIS SUS 304 is machined to a circular plate having a center opening. The vane type contact point members 1 are also machined so that the circular contact point member 2 can be engaged therewith. The vane type contact point members 1, the circular contact point member 2, and the electrode rod 3 are superimposed with solders 4 therebetween as shown in FIG. 5B. The solder 4 was of a Cu-Mn alloy. The assembly is then heated at 980° C. for eight minutes under vacuum of not higher than 8.2×10⁻⁴ Pa to obtain the electrode as shown in FIGS. 5A and 5B. The outer diameter of the reinforcement plate 5 is the same as that of the circumferentially arranged three vane type contact point members 1. Except for the above, the electrode has the same structure as that of the first embodiment.

The reinforcement plate 5 makes the fabrication of the electrode easy, since the reinforcement plate 5 can be used as a base on which the vane type contact point members 1 are placed when performing the soldering work. The reinforcement plate 5 also serves as a shield to prevent metal vapor and sputtered molten metal which occur when breaking a circuit thereby preventing deterioration of the voltage-withstanding property of the electrode.

Advantageously, a protrusion may be provided on the back surface each of the vane type contact point members 1 and recesses corresponding to the protrusions may be provided to the reinforcement plate 5 in order to engage the protrusions and the recesses with one another, whereby the vane type contact point members 1 can be easily positioned on the reinforcement plate 5 when fabricating the electrode by soldering, so that the workability is improved.

### Example 3

FIG. 6 shows a conventional contact point 6 as a comparative example which is an integral vane type being provided with vane figures by forming slit-grooves 6a.

This conventional contact point member is produced as follows. A mixture of a copper powder as a high-conductivity metal and a chromium powder as a heat-resistant metal in a composition rate of, by weight, Cu:Cr=75:25, is filled in a forming and compacting die to produce an integral vane type contact point member 6, which has dimensions as shown in FIG. 2, by sintering. The powder mixture has the same particle size as that of producing the vane type contact point member 1. The powder mixture filled in the die was compacted by a hydraulic press under a pressure of 120 MPa. The thus obtained compact had a relative density of 61%. The compact was sintered under the same conditions as those of sintering to produce the vane type contact point members 1 so that the integral contact point member 6, as shown in FIG. 6, was produced.

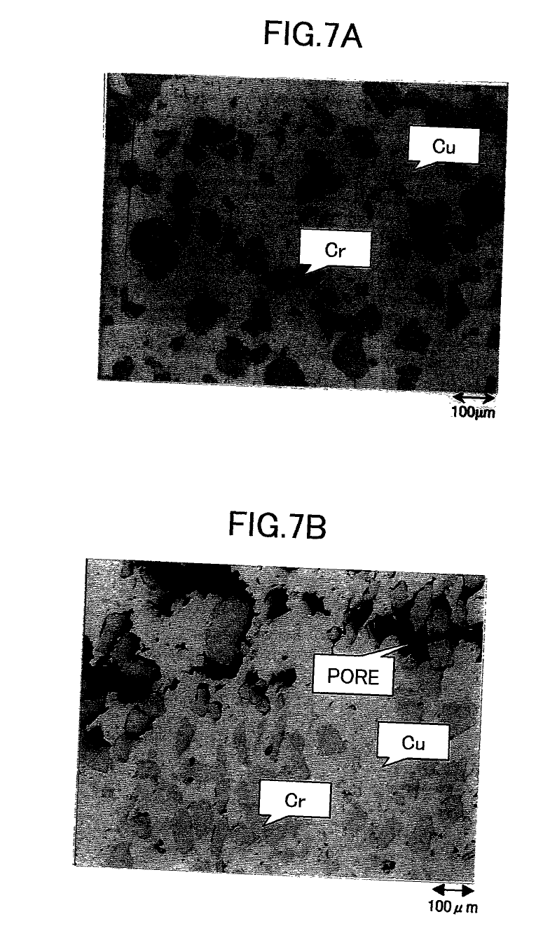

FIG. 7A is an optical microscopic photograph showing the micro-structure of a vane type contact point member 1 of the first embodiment, and FIG. 7B is an optical microscopic photograph showing the micro-structure of the comparative example of the integral vane type contact point member 6. It can be seen in FIG. 7A that the vane type contact point member 1 has a generally uniform and fine micro-structure by virtue of the die having a simple forming cavity according to which the raw metal powder can be filled uniformly in the die and advantageously it is hard to adhere to the die under an increased high pressure. In contrast, the integral vane type contact point member 6 shown in FIG. 7B has a non-uniform micro-structure with some pores due to the die having a complex forming cavity according to which the raw metal powder is filled in the die non-uniformly and it cannot help press-forming under a low pressure because the raw metal powder is liable to adhere to the die under a high pressure. Comparing the vane type contact point member 1 and the integral vane type contact point member 6 by measuring those relative densities, the former has 98% and the latter has 86%.

Thus, according to the invention, a contact point having a fine and uniform micro-structure can be produced comparatively easily by using such vane type contact point members 1 each having a simple form. It is also possible to produce the contact point members at a low cost, since a forming die and a press-forming machine, each having a simple form or structure, can be used. In addition, although the vane type contact point member 1 is a sintered product, it has a high density (i.e. a low porosity), so that it can be machined with utilization of a machining oil since the oil can be removed from the product by subsequent cleaning, heat treatment and so on, whereby the working time can be significantly reduced.

### Example 4

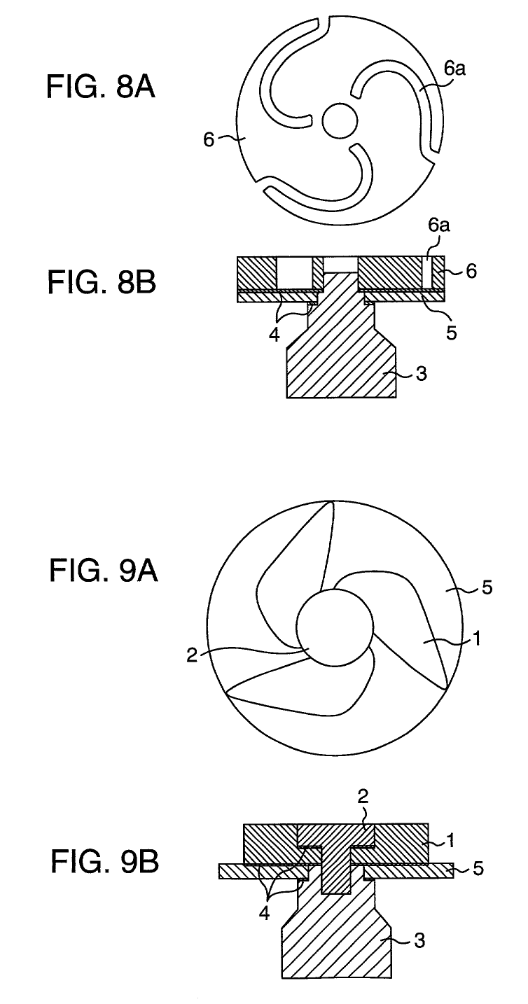

FIGS. 8A and 8B show an electrode comprising an integral vane type contact point member 6 according to Example 3, a electrode rod 3 and a reinforcement plate 5. The method of producing it is the same as that of the electrode according to Example 2 as shown in FIGS. 5A and 5B. The electrode rod 3 is made of an oxygen-free copper. The reinforcement plate 5 is made from stainless steel (JIS SUS 304) by machining. The integral vane type contact point member 6 made of a sintered alloy, the reinforcement plate 5 and electrode rod 3 are assembled together with interposed solders 4 by fitting a thinned end part of the electrode rod 3 into center openings of the members 5 and 6. The assembly are heated at a temperature of 980° C. for 8 minutes under vacuum of not higher than 8.2×10⁻⁴ Pa to produce the electrode as shown in FIGS. 8A and 8B. The integral vane type contact point member 6 is of a circular form with a center opening and has slit grooves 6a formed by machining extending from the center region to the peripheral region thereof. The integral vane type contact point member 6 and the reinforcement plate 5 have the same diameter. Since the sintered product of the integral contact point member has a flat form, it can have a high density and significantly less defects.

### Example 5

FIG. 9 shows an electrode that utilizes a circular contact point member 2 having a flat top at its center. The method of manufacturing the circular contact point member 2 is the same as that in Example 1 described above in connection with FIGS. 3A and 3B, except that a forming and compacting die used for this contact point member 2 is adapted to provide a flat top to the member 2. Conditions including soldering for fabricating the electrode are the same as that in Example 2 shown in FIGS. 5A and 5B. The vane type contact point members 1 are entirely soldered to the upper surface of the reinforcement plate 5. The circular contact point member 2 is soldered to the vane type contact point member 1, which is soldered to the reinforcement plate 5. The circular contact point member 2 is also soldered to the electrode rod 3.

### Example 6

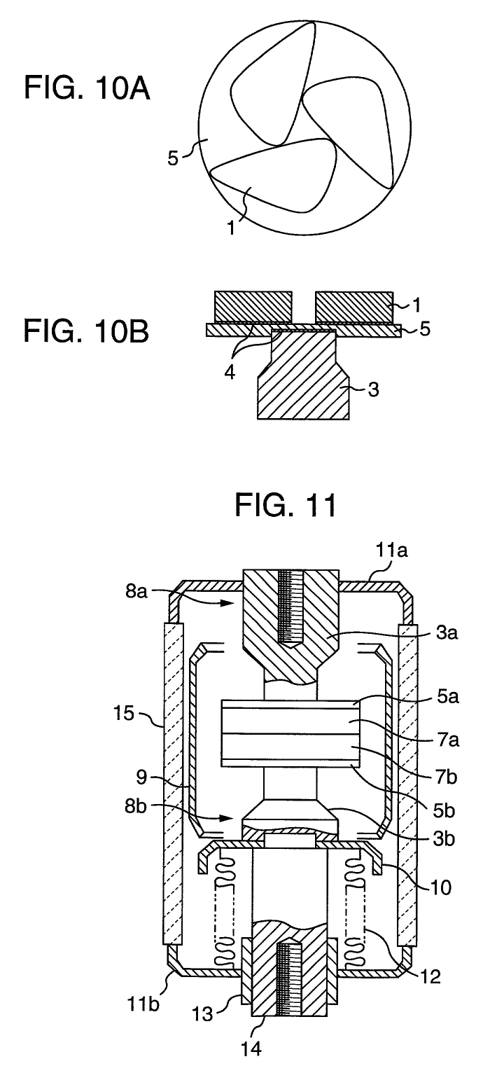

FIG. 10 shows an electrode without the circular contact point member 2. The method of manufacturing this electrode is as follows. A number of vane type contact point members 1 made by the method in Example 1 are placed on a reinforcement plate 5 in a circumferential arrangement together with an interposed solder 4 as shown in FIGS. 10A and 10B. They are then placed on an electrode rod 3 via solder 4, and heated in the same manner as that in Example 2 shown in FIGS. 5A and 5B. The reinforcement plate 5 is made of a copper-based alloy with chromium. The vane type contact point members 1 are entirely soldered to the upper surface of the reinforcement plate 5. The reinforcement plate 5 is soldered to the vane type contact point member 1 and the electrode rod 3.

### Example 7

FIG. 11 is a sectional view of a vacuum valve utilizing any one of the electrodes in Examples 1 to 6. In FIG. 11, 7a and 7b denote a stationary side and a movable side contact points, respectively, 5a and 5b reinforcement plates, respectively, and 3a and 3b a stationary side and a movable side electrode rods, respectively, which form a stationary side electrode 8a and a movable side electrode 8b, respectively. The movable side electrode 8b is soldered to a movable side holder 14 via a movable side shield 10 for stopping sputtered metal vapor generated when breaking circuit. These elements are enclosed in a high-vacuum container made up of a stationary side and a movable side end panels 11a and 11b, respectively, and an insulating cylinder 15, which are all soldered together. The electrodes can be connected with external conductors with screws provided in the stationary side electrode 8a and the movable side holder 14.

Within the insulating cylinder 15, there is provided a shield 9 for shielding sputtered metal vapor generated when breaking circuit. Provided between the movable side end panel 11b and the movable side holder 14 is a guide 13 for slidably supporting the holder 14. Provided between the movable side shield 10 and the movable side end panel 11b is a bellows 12 for allowing the movable side holder 14 to move up and down maintaining the vacuum in the vacuum valve while closing/opening the stationary side and movable side electrodes 8a and 8b. In accordance with the embodiment, various vacuum valves having a structure as shown in FIG. 11 can be formed using different types of the electrodes shown in FIGS. 5A, 5B, 6, 9A, 9B, 10A and 10B for example for the stationary side and the movable side electrodes 8a and 8b, respectively.

Table 1 shows the results of experiment performed on the vacuum valves installed in a vacuum circuit breaker. Measured maximum breaking currents and withstanding voltages shown in Table 1 are given as the ratios to the corresponding values measured for a conventional vacuum circuit breaker. It is seen from the table that a vacuum valve which has flat circular contact point members 2 of FIGS. 9A and 9B has a smaller maximum breaking current as compared with a vacuum valve which has electrodes having central recesses of FIGS. 5A and 5B. This is due to the fact that arcs generated stays at the center of the electrodes in the former vacuum valve. It is also seen from the Table that, without the circular contact point member 2 shown in FIGS. 10A and 10B, the maximum breaking current is small. This is because the electrodes are entirely made of a 35Cr-65Cu alloy which has a large electric resistance. In this case, withstanding-voltage is also small because the joints of the vane type contact point members 1 are exposed. It should be appreciated, however, that the vacuum valves that utilizes the inventive electrodes all exhibit larger maximum shut-off currents and larger withstanding voltages as compared with conventional ones having a structure as shown in FIG. 8. It should be noted that the vane type contact point member 1 has a lower porosity than the integral vane type contact point member 6, that is, former member 1 has a more uniform and more fine micro-structure than the latter member 6, so that the former member 1 is hard to occur flowing of moltencopper into pores and melting of the electrode due to local heating. From these observations, it is confirmed that the electrode manufactured in accordance with the invention is excellent in breaking, voltage-withstanding, and non-melting properties.

TABLE 1

| | Electrode | | | | | |
|---|---|---|---|---|---|---|
| | Structure | | | | | Melting of |
| | | Vane type | Circular | Maximum | | Electrode after |
| | | contact | Contact | Breaking | Withstanding | Nominal Short- |
| | Drawing | point | Point | Current | Voltage | time Current × 2 sec |
| Invention | | Composition: | Composition: | 1.42 | 1.25 | None |
| Example | | 35Cr—65Cu | 25Cr—75Cu | | | |
| | | | (Recessed Top) | | | |
| | | | Composition: | 1.27 | 1.25 | None |
| | | | 25Cr-75Cu | | | |
| | | | (Flat Top) | | | |
| | | | — | 1.13 | 1.20 | None |
| Comparative | | (Integral | — | 1.00 | 1.00 | Yes |
| (conventional) | | Vane type) | | | | |
| Example | | Composition: | | | | |
| | | 25Cr—75Cu | | | | |

The invention vacuum breaker comprises:

a vacuum valve having a stationary side electrode and a movable side electrode in a vacuum container;

conductive terminals, each connected to the stationary side electrode and the movable side electrode, for connection with external components; and

opening/closing means for driving the movable side electrode.

In accordance with the embodiment, complex electrodes having a high and uniform density may be obtained from simple vane type contact point members. Thus, the electrodes have stable breaking performance. Since the invention contact point members have a simple form, an inexpensive press-forming machine and an inexpensive dies can be used for compacting the metal powder for the contact points.

The radius of an electrode can be arbitrarily chosen by adjusting the number and the angular spacing of radial vane type contact point members, so that contact points having varied electric capacities can be manufactured at low costs using identical vane type contact members, which in turn enables production of low cost vacuum valves.

According to the invention, uniform, high-density electrodes having stable breaking property can be produced from a plurality of simple vane type contact point members. Since the vane type members are simple in form, a press machine and a die therefor are inexpensive, which permits reduction of the manufacturing costs of the electrodes.

The diamter of an electrode can be optionally selected by adjusting the number and the angular spacing of the vane type contact point members, so that contact points having varied electric capacities can be produced at a low cost using identical vane type contact members, which in turn enables production of low cost vacuum valves.

What is claimed is:

1. An electrode of a vacuum valve, comprising:
a contact point being made of a sintered alloy comprising a heat-resistant metal and a high-conductivity metal;
an electrode rod being bonded to said contact point by soldering to said contact point, wherein
said contact point has at least three slit grooves each extending from the central region to the peripheral region of said contact point.

2. An electrode of a vacuum valve according to claim 1, wherein said contact point is provided with a recess at the center thereof.

3. An electrode of a vacuum valve, comprising:
a contact point being made of a sintered alloy comprising a heat-resistant metal and a high-conductivity metal;
a reinforcement plate being connected to the back surface of said contact point; and
an electrode rod being connected to said contact point and said reinforcement plate, wherein
said reinforcement plate is soldered to said contact point and said electrode rod; and
said contact point has at least three slit grooves extending from the central region to the peripheral region of said contact point.

4. An electrode of a vacuum valve according to claim 3, wherein said contact point is provided with a recess at the center thereof.

5. An electrode of a vacuum valve, comprising:
a vane type contact point having a vane type divided form being made of a sintered alloy comprising a heat-resistant metal and a high-conductivity metal;
an electrode rod being connected to said contact point by soldering, wherein
said contact point having a vane type divided form has at least three vane type members which are arranged around said electrode rod as if they form a vane wheel.

6. An electrode of a vacuum valve, comprising:
a contact point having a vane type divided form being made of a sintered alloy comprising a heat-resistant metal and a high-conductivity metal;
a circular contact point member being made of a sintered alloy comprising a heat-resistant metal and a high-conductivity metal and arranged at the inner circumferential region of said contact point; and
an electrode rod being connected to said circular contact point member, wherein
said circular contact point member and said electrode rod are bonded by soldering with each other; and
said contact point having a vane type divided form has at least three vane type members which are arranged around said circular contact point member as if they form a vane wheel.

7. An electrode of a vacuum valve, comprising:
a contact point having a vane type divided form made of a sintered alloy comprising a heat-resistant metal and a high-conductivity metal;
a reinforcement plate being connected to the back surface of said contact point;
a circular contact point member being made of a sintered alloy comprising a heat-resistant metal and a high-conductivity metal, and arranged at the inner circumferential region of said contact point; and
an electrode rod connected to said circular contact point member, wherein
said contact point having a vane type divided form and said reinforcement plate are bonded with each other by soldering;
said circular contact point member and said electrode rod are bonded with each other by soldering; and wherein
said contact point having a vane type divided form has at least three vane type members which are arranged around said circular contact point member as if they form a vane wheel.

8. An electrode of a vacuum valve according to claim 5, wherein said circular contact point member comprises a lower amount of said heat-resistant metal than said contact point having a vane type divided form.

9. An electrode of a vacuum valve according to claim 6, wherein said circular contact point member comprises a lower amount of said heat-resistant metal than said contact point having a vane type divided form.

10. An electrode of a vacuum valve according to claim 6, wherein said circular contact point member has an electric conductivity larger than said contact point having a vane type divided form.

11. An electrode of a vacuum valve according to claim 7, wherein said circular contact point member has an electric conductivity larger than said contact point having a vane type divided form.

12. An electrode of a vacuum valve according to claim 6, wherein said circular contact point member has a central recess.

13. An electrode of a vacuum valve according to claim 7, wherein said circular contact point member has a central recess.

14. An electrode of a vacuum valve according to claim 1, wherein
said heat-resistant metal consists of one or more elements selected from the group of Cr, W, Mo, Ta, Nb, Be, Hf, Ir, Pt, Zr, Ti, Te, Si, Rh and Ru, or an alloy comprising one of the elements as a primary element; and
said high-conductivity metal consists of one or more elements selected from the group of Cu, Ag and Au, or an alloy comprising one of the elements of Cu, Ag and Au as a primary element.

15. An electrode of a vacuum valve according to claim 3, wherein
said heat-resistant metal consists of one or more elements selected from the group of Cr, W, Mo, Ta, Nb, Be, Hf, Ir, Pt, Zr, Ti, Te, Si, Rh and Ru, or an alloy comprising one of the elements as a primary element; and
said high-conductivity metal consists of one or more elements selected from the group of Cu, Ag and Au, or an alloy comprising one of the elements of Cu, Ag and Au as a primary element.

16. An electrode of a vacuum valve according to claim 5, wherein
said heat-resistant metal consists of one or more elements selected from the group of Cr, W, Mo, Ta, Nb, Be, Hf, Ir, Pt, Zr, Ti, Te, Si, Rh and Ru, or an alloy comprising one of the elements as a primary element; and
said high-conductivity metal consists of one or more elements selected from the group of Cu, Ag and Au, or an alloy comprising one of the elements of Cu, Ag and Au as a primary element.

17. An electrode of a vacuum valve according to claim 6, wherein
said heat-resistant metal consists of one or more elements selected from the group of Cr, W, Mo, Ta, Nb, Be, Hf, Ir, Pt, Zr, Ti, Te, Si, Rh and Ru, or an alloy comprising one of the elements as a primary element; and
said high-conductivity metal consists of one or more elements selected from the group of Cu, Ag and Au, or an alloy comprising one of the elements of Cu, Ag and Au as a primary element.

18. An electrode of a vacuum valve according to claim 7, wherein
said heat-resistant metal consists of one or more elements selected from the group of Cr, W, Mo, Ta, Nb, Be, Hf, Ir, Pt, Zr, Ti, Te, Si, Rh and Ru, or an alloy comprising one of the elements as a primary element; and
said high-conductivity metal consists of one or more elements selected from the group of Cu, Ag and Au, or an alloy comprising one of the elements of Cu, Ag and Au as a primary element.

19. An electrode of a vacuum valve according to claim 1, wherein said heat-resistant metal comprises 50 to 2000 ppm of oxygen, 50 to 3000 ppm of aluminum, and 400 to 2500 ppm of silicon.

20. An electrode of a vacuum valve according to claim 3, wherein said heat-resistant metal comprises 50 to 2000 ppm of oxygen, 50 to 3000 ppm of aluminum, and 400 to 2500 ppm of silicon.

21. An electrode of a vacuum valve according to claim 5, wherein said heat-resistant metal comprises 50 to 2000 ppm of oxygen, 50 to 3000 ppm of aluminum, and 400 to 2500 ppm of silicon.

22. An electrode of a vacuum valve according to claim 5, wherein said heat-resistant metal comprises 50 to 2000 ppm of oxygen, 50 to 3000 ppm of aluminum, and 400 to 2500 ppm of silicon.

23. An electrode of a vacuum valve according to claim 6, wherein said heat-resistant metal comprises 50 to 2000 ppm of oxygen, 50 to 3000 ppm of aluminum, and 400 to 2500 ppm of silicon.

24. An electrode of a vacuum valve according to claim 7, wherein said heat-resistant metal comprises 50 to 2000 ppm of oxygen, 50 to 3000 ppm of aluminum, and 400 to 2500 ppm of silicon.

25. A method of manufacturing an electrode of a vacuum valve, said electrode comprising:
a contact point being made of a sintered alloy comprising a heat-resistant metal and a high-conductivity metal; and
an electrode rod being bonded to said contact point by soldering to said contact point, wherein
said contact point has at least three slit grooves each extending from the central region to the peripheral region of said contact point, the method comprising the steps of:
compacting an alloy powder comprising a heat-resistant metal and a high-conductivity metal, or a mixture of a heat-resistant metal powder and a high-conductivity metal powder to have a predetermined form; and
sintering the thus obtained compact by heating.

26. A method of manufacturing an electrode of a vacuum valve, said electrode comprising:
a contact point having a vane type divided form made of a sintered alloy comprising a heat-resistant metal and a high-conductivity metal; and
an electrode rod being bonded to said contact point by soldering to said contact point, wherein
said contact point has at least three vane type members which are arranged around said electrode rod as if they form a vane wheel,
the method comprising the steps of:
compacting an alloy powder comprising a heat-resistant metal and a high-conductivity metal, or a mixture of a heat-resistant metal powder and a high-conductivity metal powder to have a predetermined form; and
sintering the thus obtained compact by heating.

27. A method of manufacturing an electrode of a vacuum valve according to claim 25, wherein said contact point comprises 15 to 40 wt % of said heat-resistant metal and 60 to 85 wt % of said high-conductivity metal.

28. A method of manufacturing an electrode of a vacuum valve according to claim 26, wherein said contact point comprises 15 to 40 wt % of said heat-resistant metal and 60 to 85 wt % of said high-conductivity metal.

29. A method of manufacturing an electrode of a vacuum valve according to claim 25, wherein said compacting is carried out under a pressure of 120 to 500 MPa.

30. A method of manufacturing an electrode of a vacuum valve according to claim 26, wherein said compacting is carried out under a pressure of 120 to 500 MPa.

31. A method of manufacturing an electrode of a vacuum valve according to claim 25, wherein said powdered mixture/alloy has particle sizes of not more than 104 micrometers.

32. A method of manufacturing an electrode of a vacuum valve according to claim 26, wherein said powdered mixture/alloy has particle sizes of not more than 104 micrometers.

33. A vacuum valve, comprising a pair of stationary electrode and a movable electrode in a vacuum container, wherein at least one of said stationary electrode and said movable electrode is the electrode defined in claim 1.

34. A vacuum valve, comprising a pair of a stationary electrode and a movable electrode in a vacuum container, wherein at least one of said stationary electrode and said movable electrode is the electrode defined in claim 3.

35. A vacuum valve, comprising a pair of a stationary electrode and a movable electrode in a vacuum container, wherein at least one of said stationary and movable electrodes is the electrode as defined in claim 5.

36. A vacuum valve, comprising a pair of a stationary electrode and a movable electrode in a vacuum container, wherein at least one of said stationary and movable electrodes is the electrode as defined in claim 6.

37. A vacuum valve, comprising a pair of stationary electrode and a movable electrode in a vacuum container, wherein at least one of said stationary electrode and said movable electrode is the electrode as defined in claim 7.

38. A vacuum circuit-breaker having:
a vacuum valve having a stationary electrode and a movable electrode in a vacuum container;
conductive terminals connected with the respective stationary and movable electrodes;
an opening/closing means for driving said movable electrode, said vacuum circuit-breaker comprising the vacuum valve as defined in claim 34.

39. A contact point of an electrode of a vacuum valve, comprising a sintered alloy slab of a heat-resistant metal and a high-conductivity metal, wherein said contact point has at least three slit grooves extending from the central region to the peripheral region of said contact point.

40. A contact point of an electrode of a vacuum valve, comprising a vane type contact point having a flat plate form and being made of a sintered alloy comprising a heat-resistant metal and a high-conductivity metal.
